(19) United States
(12) Patent Application Publication
(10) Pub. No.: US 2014/0297896 A1
(43) Pub. Date: Oct. 2, 2014

(54) INPUT SYSTEM AND METHOD FOR COMPUTERS

(71) Applicants: HON HAI PRECISION INDUSTRY CO., LTD., New Taipei (TW); HONG FU JIN PRECISION INDUSTRY (Shenzhen) CO., LTD., Shenzhen (CN)

(72) Inventor: MENG-LIANG YANG, Shenzhen (CN)

(73) Assignees: HON HAI PRECISION INDUSTRY CO., LTD., New Taipei (TW); HONG FU JIN PRECISION INDUSTRY (Shenzhen) CO., LTD., Shenzhen (CN)

(21) Appl. No.: 14/226,632

(22) Filed: Mar. 26, 2014

(30) Foreign Application Priority Data
Mar. 28, 2013 (CN) 2013101042558

(51) Int. Cl. G06F 13/10

(52) U.S. Cl. CPC G06F 13/10
USPC 710/10

(57) ABSTRACT

An input system includes a number of computers, a keyboard, and a mouse. Each computer includes an adapter. The keyboard includes a sender and a receiver. The mouse includes a sending device. The sender of the keyboard selectively communicates with at least one of the computer through corresponding adapter. The mouse communicates to the selected computer through the receiver, the sender, and the adapter of the selected computer.

### FIELD

The present disclosure relates to an input system and a method for computers.

### BACKGROUND

Wired keyboards and mice become essential parts of a standard computer. However, the wired keyboards and/or mice can become a tangled mess, which may be inconvenient when needed to connect or disconnect from the computer.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an embodiment of an input system of the present disclosure, wherein the input system comprises a control circuit.

FIG. 2 is a block diagram of the control circuit of FIG. 2, wherein the control circuit comprises a storage device and a processor.

FIG. 3 is a block diagram of the storage device and the processor of FIG. 2, wherein the storage device comprises a matching table.

FIG. 4 is a block diagram of the matching table of FIG. 3.

FIG. 5 is a flow chart of an embodiment of an input method of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

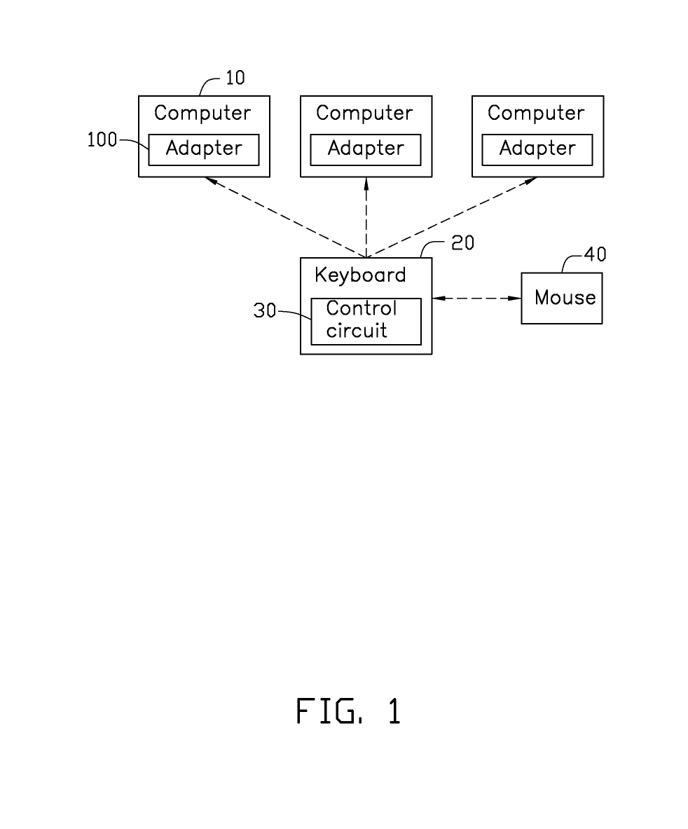

FIG. 1 illustrates an input system for a plurality of computers 10 according to the present disclosure. Each computer 10 is equipped with an adapter 100. The input system comprises a keyboard 20 selectively active as an input device for one of the computers 10, and a mouse 20 communicating to the selected computer 10 through the keyboard 20. The keyboard 20 comprises a control circuit 30 and keys (not shown) performing certain functions, such as first operations of characters and/or inputting commands.

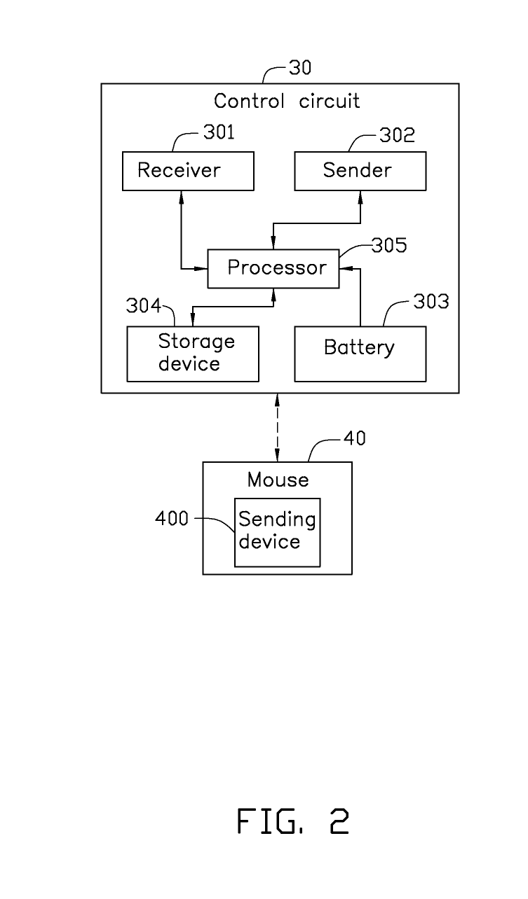

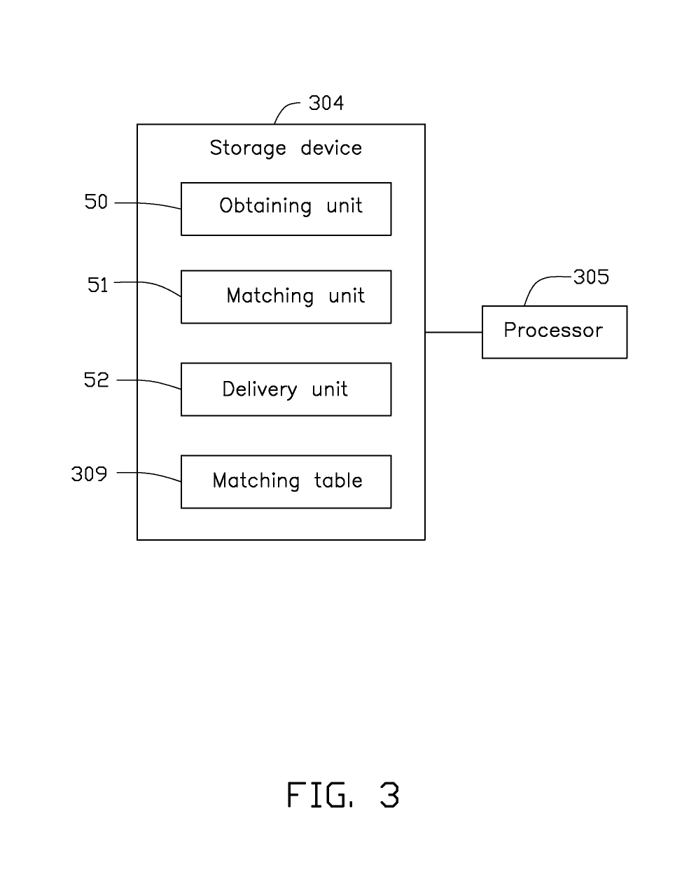

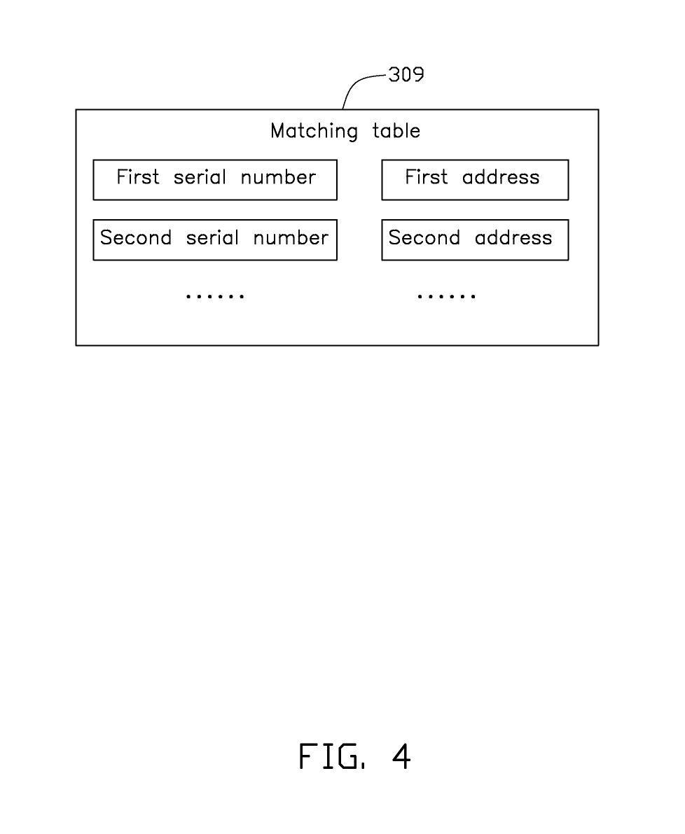

FIGS. 2-4 illustrate that the control circuit 30 comprises a receiver 301, a sender 302, a battery 303, a storage device 304, and a processor 305. The mouse 40 comprises a sending device 400. The battery 303 provides voltage for the processor 305, the receiver 301, the sender 302, and the storage device 304.

The receiver 301 matches with the sending device 400 of the mouse 40, to receive second operations of the mouse 40, such as second operations of double-click, or single-click, for example. In the embodiment, the receiver 301 and the sending device 400 are BLUETOOTH components. The sender 302 matches with the adapter 100, to send the first and/or second operations to the selected computer 10. The sender 302 and the adapter 100 can also be BLUETOOTH components.

The processor 305 can be coupled to the storage device 304. The storage device 304 can store a matching table 309 and a plurality of programs to be executed by the processor 305 to perform certain functions. The storage device 304 comprises an obtaining unit 50, a matching unit 51, and a delivery unit 52.

The matching table 309 comprises an address of the adapter 100 of each computer 10 and a serial number corresponding to each address. For example, a first serial number can correspond to a first address of a first adapter; a second serial number can correspond to a second address of a second adapter. Each serial number is used to perform matching operation between the sender 301 and the adapter 100 of the corresponding computer. In one embodiment, each serial number manually inputted can correspond to a character. For example, a character “1” can correspond to the first serial number; a character “2” can correspond to the second serial number.

The obtaining unit 50 receives a first character from a user, representing the computer to be selected. For instance, the user can input the first character “1” from the keyboard. The obtaining unit 50 then further obtains the address and the serial number from the matching table 309, according to the character, such as obtaining the first address and the first serial number according to the first character.

The matching unit 51 can determine whether the sender 302 matches the adapter of the selected computer, according to the address and the serial number selected from the match table 309.

The delivery unit 52 delivers the first operations of the keyboard to the selected computer through the sender 302 and the adapter after the sender 302 matching the adapter of the selected computer, to enable the keyboard to be active as an input device for the selected computer.

The matching unit 51 determines whether the receiver 301 matches the sending device 400 of the mouse 40.

When the receiver 301 matches the sending device 400, the delivery unit 52 further delivers the second operation of the mouse 40 to the selected computer through the sender 302 and the adapter. Accordingly, the mouse 40 and the keyboard both can be active as input devices for the selected computer.

When the keyboard and the mouse 40 need to act as the input devices for another computer, a second character representing another computer can be input through the keyboard. The control circuit 30 of the keyboard 40 then selects the corresponding address and serial number according to the second character, and makes the keyboard 20 and the mouse 40 the input devices for another computer.

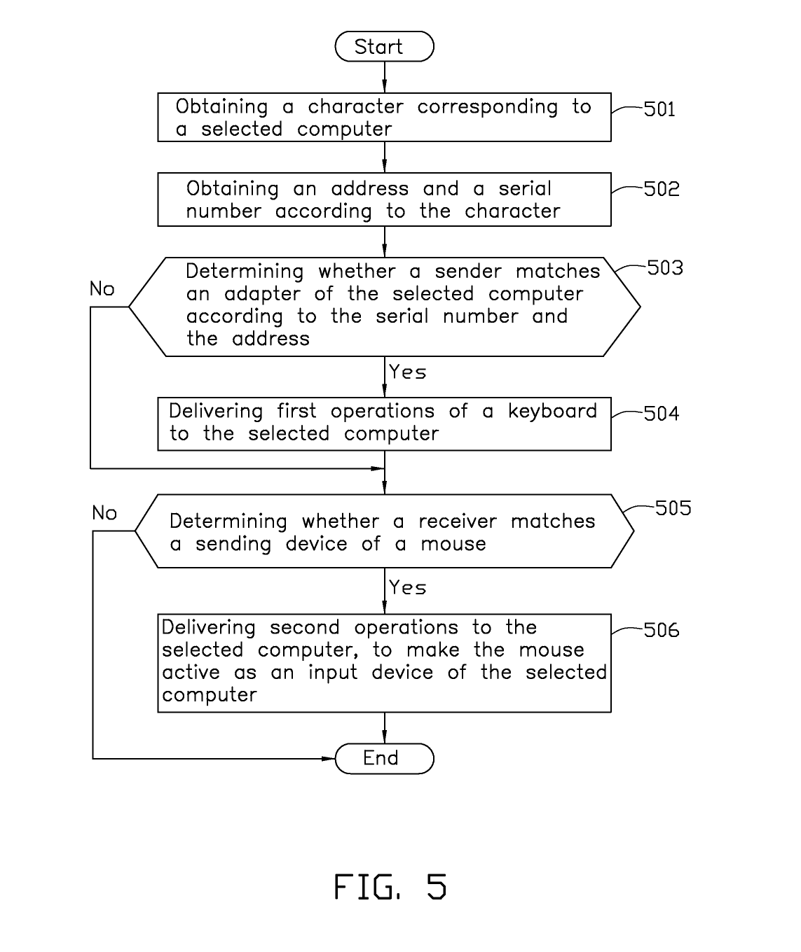

FIG. 5 shows an input method of the present disclosure.

In 501, the control circuit can obtain a character corresponding to a selected computer 10.

In 502, the control circuit can obtain an address and a serial number according to the character.

In 503, the control circuit determines whether the sender matches the adapter 100 of the selected computer. If the sender matches the adapter of the selected computer, 504 is implemented. If the sender does not match the adapter of the selected computer, 505 is implemented.

In 504, the control circuit can deliver the first operations of the keyboard to the selected computer upon the sender matching the adapter of the selected computer, to make the keyboard active as an input device for the selected computer.

In 505, the control circuit determines whether the receiver matches the sending device of the mouse. If the receiver matches the sending device of the mouse, 506 is implemented. If the receiver does not match the sending device of the mouse, the process ends.

In 506, the control circuit can deliver the second operation to the selected computer upon the receiver matching the sending device of the mouse, to make the mouse an input device of the selected computer.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar.

What is claimed is:

1. An input system, comprising:
a plurality of computers each equipped with an adapter, wherein the adapter of each of the computers assigned with an address;
a keyboard, comprising:
a sender selectively communicating with the adapter of one of the computers;
a processor; and
a storage device storing a matching table, wherein the matching table comprises the address of the adapter of each of the computers and a serial number corresponding to each address; the storage device further stores a plurality of programs to be executed by the processor to perform certain functions, wherein the storage device further comprising:
an obtaining unit obtaining the address of a selected computer from the matching table, wherein the obtaining unit further obtains the serial number of the selected computer according to the obtained address;
a matching unit determining whether the sender matches the adapter of the selected computer; and
a delivery unit delivering first operations of the keyboard to the selected computer, in response to the sender matching the adapter of the selected computer.

2. The input system of claim 1, wherein each address corresponds to a character, the obtaining unit obtains the address of the selected computer according to the character being received.

3. The input system of claim 2, wherein the sender and the adapter are BLUETOOTH components.

4. The input system of claim 2, further comprising:
a mouse comprising a sending device, wherein the keyboard further comprises a receiver; the matching unit further determines whether the receiver matches the sending device, the delivery unit further outputs second operations of the mouse to the selected computer through the sender and the adapter of the selected computer, in response to the receiver matching the sending device.

5. The input system of claim 4, wherein the receiver and the sending device are BLUETOOTH components.

6. The input system of claim 5, wherein the character is inputted through the keyboard.

7. The input system of claim 1, further comprising:
a mouse comprising a sending device, wherein the keyboard further comprises a receiver; the matching unit further determines whether the receiver matches the sending device, the delivery unit further outputs second operations of the mouse to the selected computer through the sender and the adapter of the selected computer, in response to the receiver matching the sending device.

8. The input system of claim 7, wherein the receiver and the sending device are BLUETOOTH components.

9. The input system of claim 7, wherein the sender and the adapter are BLUETOOTH components.

10. An input method, comprising:
receiving a character corresponding to an adapter of a selected computer;
obtaining an address and a serial number according to the character by a keyboard;
determining whether a sender of the keyboard matches the adapter of the selected computer; and
delivering first operations of the keyboard to the selected computer through the sender and the adapter of the selected computer, in response to the sender of the keyboard matches the adapter of the selected computer.

11. The input method of the claim 10, further comprising:
performing second operations by a mouse;
determining whether a receiver of the keyboard matches a sending device of the mouse; and
delivering second operations to the selected computer through the sender and the adapter of the selected computer, in response to the receiver of the keyboard matching the sending device of the mouse.

12. The input method of claim 11, wherein the receiver and the sending device are BLUETOOTH components.

13. The input method of claim 11, wherein the sender and the adapter are BLUETOOTH components.

14. An input system, comprising:
a sender selectively communicating with an adapter of one of a plurality of computers;
a processor; and
a storage device storing a plurality of programs to be executed by the processor to perform certain functions, wherein the storage device further comprising:
an obtaining unit obtaining a character corresponding to a selected computer of one of the plurality of computers; and
a delivery unit delivering first operations of a keyboard to the selected computer upon receiving the character.

15. The input system of claim 14, wherein the storage device further stores a matching table, wherein the matching table comprises the address of the adapter of each computer and a serial number corresponding to each address, the storage device further comprises:
an obtaining unit obtaining the address of the selected computer from the matching table according to the character, wherein the obtaining unit further obtains the serial number of the selected computer according to the address;
a matching unit determining whether the sender matches the adapter of the selected computer;
wherein the delivery unit delivers the first operations of the keyboard to the selected computer, in response to the sender matching the adapter of the selected computer.

16. The input system of claim 15, wherein the delivery unit further delivers second operations of a mouse to the selected computer.

17. The input system of claim 16, wherein the mouse comprises a sending device, the keyboard further comprises a receiver; the matching unit further determines whether the receiver matches the sending device, the delivery unit further outputs second operations of the mouse to the selected computer through the sender and the adapter of the selected computer, in response to the receiver matching the sending device.

18. The input system of claim 17, wherein the receiver and the sending device are BLUETOOTH components.

19. The input system of claim 17, wherein the sender and the adapter are BLUETOOTH components.
